(19) United States
(12) Patent Application Publication
(10) Pub. No.: US 2015/0379721 A1
(43) Pub. Date: Dec. 31, 2015

(54) WINDROW RELATIVE YIELD DETERMINATION THROUGH STEREO IMAGING

(71) Applicants: Justin BAK, Windom, MN (US); AGCO CORPORATION, Duluth, GA (US)

(72) Inventors: Grant Lewis Good, Moundridge, KS (US); Michael Lee O'Halloran, Hesston, KS (US); Justin Bak, Windom, MN (US)

(21) Appl. No.: 14/432,277

(22) PCT Filed: Sep. 27, 2013
(86) PCT No.: PCT/US13/62107

§ 371 Date: Mar. 30, 2015

Related U.S. Application Data
(60) Provisional application No. 61/706,971, filed on Sep. 28, 2012.

(51) Int. Cl. G06T 7/00; G06T 7/60; H04N 7/18

(52) U.S. Cl. CPC G06T 7/0075; H04N 7/181; G06T 7/602; G06T 2207/10021; G06T 2207/30188

(57) ABSTRACT

A method that that captures images of a windrow and determines a cross section of the windrow based on the captured images to provide a yield map.

### CROSS REFERENCE TO RELATED APPLICATION

This application claims the benefit of U.S. Provisional Application No. 61/706,971, filed Sep. 28, 2012, which is hereby incorporated by reference in its entirety.

### TECHNICAL FIELD

The present disclosure is generally related to agriculture technology, and, more particularly, precision farming.

### BACKGROUND

Yield mapping has been used in crop farming operations to boost efficiency of the production system through use of variable rate technology for subsequent cropping seasons. For instance, a determination of yield may assist in generating a variable rate application for fertilizer or other product, prioritizing resources to identified areas of higher production potential, and/or devoting fewer resources to areas of lower potential.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram of an example agricultural machine in which an embodiment of a windrow relative yield determination (WRYD) system may be implemented.

FIG. 1B is a schematic diagram of another example agricultural machine in which an embodiment of a WRYD system may be implemented.

FIG. 2 is a schematic diagram illustrating a rear-elevation view of an agricultural machine having an example imaging system mounted thereon.

FIG. 3A is a block diagram of an example embodiment of a WRYD system.

FIG. 3B is a block diagram of an example embodiment of a processing system for a WRYD system.

FIG. 4 is a flow diagram that illustrates an example embodiment of a WRYD method.

FIG. 5 is a flow diagram that illustrates another example embodiment of a WRYD method.

### DESCRIPTION OF EXAMPLE EMBODIMENTS

### Overview

In one embodiment, a method that that captures images of a windrow and determines a cross section of the windrow based on the captured images to provide a yield map.

### DETAILED DESCRIPTION

Certain embodiments of a windrow relative yield determination (WRYD) system and method are disclosed that utilize use an imaging system mounted to an agricultural machine to determine the cross section of a windrow and generate a yield map based on the determined cross section. In one embodiment, a stereo image of the harvested windrow is provided based on multiple images captured using an imaging system comprising multiple cameras. The cameras are located in a position that enables capture of the entire windrow. A point cloud comprising three dimensional coordinates that provide an outline of the windrow is generated based on the stereo image, and from the point cloud, a cross sectional area of the windrow is determined. The cross sectional area, along with the area harvested and spatial data, may be used to determine a yield map of the field being harvested. Places in the field with poorly performing crop should have a relatively small cross sectional area compared to places in the field with well performing crops.

In contrast, conventional methods to determine windrow yield are based on monitoring conditioning roll pressure or conditional roll movement in the headers. Certain embodiments of WRYD systems provide an accurate relative yield without the use of moving parts or sensors.

Having summarized certain features of WRYD systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, the focus is on an imaging system mounted on an agricultural machine that produces the windrow, the imaging system embodied as plural cameras that capture an image from slightly different locations to enable a processing system to generate a stereo image from the resulting image pairs and consequently a point cloud. However, some embodiments may use another type of imaging system, such as laser radar topography, or one or more stereo cameras that provide a stereo image to the processing system. Further, the imaging system may be mounted on an agricultural machine (e.g., self-propelled) that collects the windrow (or that tows a machine that collects the windrow). As another example of understanding the below description as more illustrative than exhaustive, one area of focus is on the processing system residing in the agricultural machine. However, in some embodiments, the images (including in some embodiments the stereo images) or the determined cross sectional area may be transmitted to a remote processing system (e.g., remote computing device or wireless communications device) that determines the cross sectional area or yield map, respectively. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

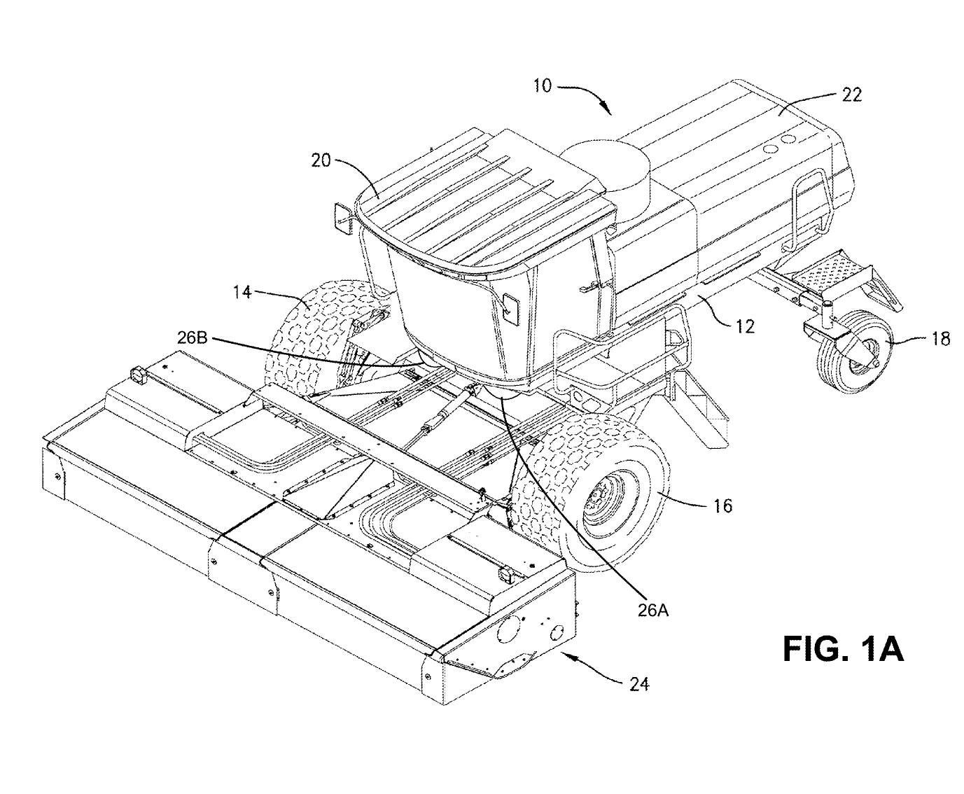

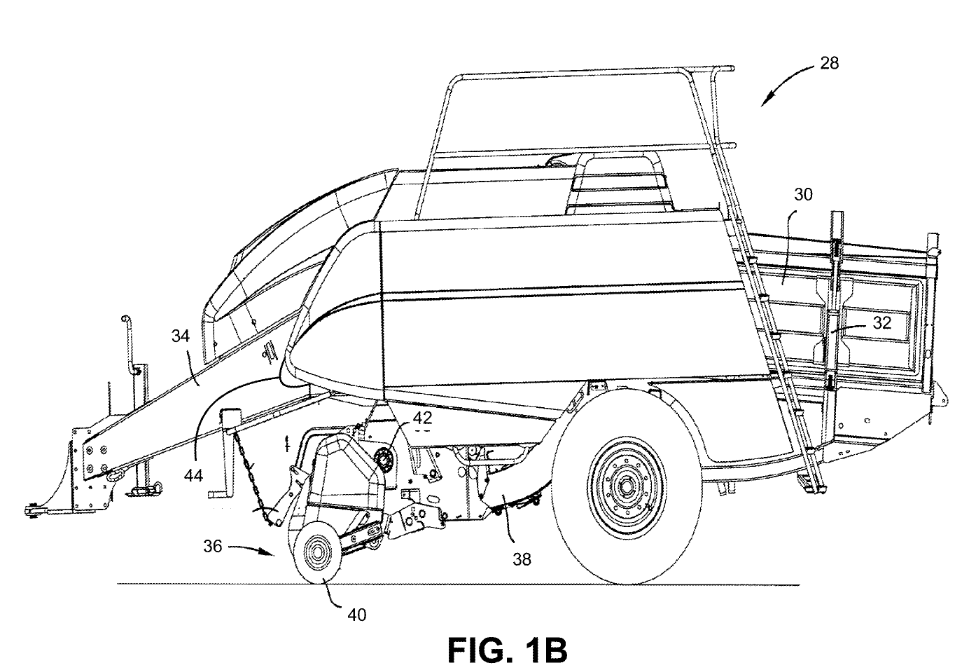

Referring now to FIG. 1A, shown is an example agricultural machine 10 embodied as a windrower (also known as a swather or generally, harvester) in which all or at least a portion of certain embodiments of WRYD systems and methods may be employed. One having ordinary skill in the art should appreciate in the context of the present disclosure that the windrower design and operation shown in, and described in association with, FIG. 1A is merely illustrative, and that other designs and/or variations in operation are contemplated to be within the scope of the disclosure. The windrower 10 shown in FIG. 1A is self-propelled, and is operable to mow and collect standing crop in the field, condition the cut material as it moves through the machine to improve its drying characteristics, and then return the conditioned material to the field in a windrow or swath. The windrower 10 includes a chassis or frame 12 supported by a pair of front drive wheels 14, 16 and a pair of rear caster wheels 18 (only the left rear caster wheel 18 being illustrated) for movement across a field to be harvested. The frame 12 carries a cab 20, within which an operator controls operation of the windrower 10, and a rearwardly spaced compartment 22 that houses a power source (not shown) such as an internal combustion engine. A harvesting header 24 is supported on the front of frame 12 in a manner well understood by those skilled in the art.

The header 24 may include a rotary cutter bed (enclosed in the header 24 and not shown) across the front of the machine that serves as a mechanism to sever standing crops as the windrower 10 advances across a field. The header 24 may also comprise a discharge opening behind the cutter bed which serves as an inlet to one or more sets of conditioner rolls. As the operation of a windrower is well-known to those having ordinary skill in the art, further discussion is omitted here for the sake of brevity. Note that some embodiments may use different header types, such as sickle-type headers.

In one embodiment, the windrower 10 comprises an imaging system mounted on one or more locations of the windrower. For instance, the imaging system may comprise plural cameras, such as cameras 26A, 26B, which are mounted in one embodiment beneath the front frame 12, above, and proximal to, the windrow deposited on the ground and proximal to the header 24. The cameras 26A, 26B are configured to operate in the visible light spectrum, and are depicted in this example as offset symmetrically across a longitudinal centerline of the windrower 10, although not necessary to be symmetrically offset or offset with respect to the centerline. The cameras 26A, 26B are positioned to capture images of the entire windrow in terms of width and height of the windrow. These pairs of images captured by the cameras 26A, 26B are used to produce stereo images and a point cloud, as described below. In some embodiments, a stereo image may be provided by the imaging system. Although described in the context of cameras operating in the visible spectrum, some embodiments of the imaging system may operate in the non-visible spectrum, such as the infrared, ultraviolet, ultrasonic, among other ranges. In some embodiments, the imaging system may be embodied as a laser radar topography system. Although the plural cameras 26A, 26B are shown mounted to the front frame 12 of the windrower 10, in some embodiments, the cameras may be located elsewhere (in addition to or in place of the depicted locations), such as coupled to, and extending from, the top or side of the cab 20 or compartment 22, mounted to the header 24, mounted more centrally to the windrower 10, among other locations. In some embodiments, the mounting of the imaging system may be adjustable, such as via a slotted track or rail to which the cameras 26A, 26B may be adjustably secured along the frame 12, header 24, or elsewhere on the windrow 10.

FIG. 1B provides another example agricultural machine embodied as a towed baler 28 (shown without the towing vehicle, such as a tractor, combine, etc.). One having ordinary skill in the art should appreciate in the context of the present disclosure that the example towed baler 28 is merely illustrative, and that other baler configurations may be employed in some embodiments. The baler 28 as illustrated in FIG. 1B has a fore-and-aft extending baling chamber 30 within which bales of crop material are prepared. In the particular illustrated embodiment, the baler 28 is an “extrusion” type baler in which the bale discharge orifice at the rear of the baler is generally smaller than upstream portions of the chamber such that the orifice restricts the freedom of movement of a previous bale and provides back pressure against which a reciprocating plunger within the baling chamber 30 can act to compress charges of crop materials into the next bale. The dimensions of the discharge orifice and the squeeze pressure on the bales at the orifice are controlled by mechanism broadly denoted by the numeral 32 in FIG. 1B. The baler 28 is hitched to a towing vehicle (not shown) by a fore-and-aft tongue 34, and power for operating the various mechanisms of the baler is supplied by the towing vehicle.

The baler 28 is an “in-line” type of baler wherein crop material, such as the windrow, is picked up below and slightly ahead of baling chamber 30 and then loaded up into the bottom of the chamber 30 in a straight line path of travel as viewed in plan. A pickup broadly denoted by the numeral 36 is positioned under the tongue 34 on the longitudinal axis of the machine, somewhat forwardly of the baling chamber 30. A charge forming duct 38 extends generally rearwardly and upwardly from a point just behind the pickup 36 to an opening in the bottom of baling chamber 30. The plunger reciprocates within the chamber 30 in compression and retraction strokes across the opening. When fully retracted, the plunger uncovers the opening, and when fully extended, the plunger completely covers and closes off the opening with the rear face of the plunger disposed somewhat rearwardly beyond the rear extremity of the opening.

The duct 38 defines an internal passage through which crop materials travel from the pickup 36 to the baling chamber 30 during operation of the baler 28. The front end of the duct 38 is open to present an inlet into the passage, and an outlet for the duct is defined by the opening into the baling chamber 30. A top wall of the duct 38 is defined by a series of laterally spaced apart straps that extend downwardly and forwardly from the baling chamber 30 and terminate in forwardmost upturned front ends generally above the inlet. The rear of the pickup 36 has a centrally disposed discharge opening, in fore-and-aft alignment with the inlet, that is formed by a pair of laterally spaced apart, left and right, concave rear wall portions.

The pickup 36, in one embodiment, has a pair of ground wheels 40 (one of the pair shown) that support the pickup as the baler advances along the ground. The pickup 36 may be mounted to the chassis of the baler 28 for pivoting movement about an upwardly and rearwardly disposed transverse pivot axis 42. Flotation for the pickup 36 may be provided by a number of different flotation mechanisms known in the art.

A relatively short, transversely channel-shaped chute projects rearwardly from the pickup opening and is slidably received within the front end of duct 38. The chute has a pair of sides and a floor, but no top, and serves as a telescoping transition piece between the pickup 36 and the duct 38 for crop flow as the pickup 36 rises and falls over uneven terrain relative to the duct 38 during operation.

The baler 28 further comprises a feeding mechanism for moving crop materials through the duct 36. Such feeding mechanism may, for example, comprise a suitable rotor associated with a cutter mechanism, or it may comprise other apparatus. In one embodiment, the feeding mechanism may include a packer and a separate stuffer. As is conventional and well understood by those skilled in the art, the packer may include a plurality of packing forks that are mounted along a crankshaft and controlled by control links for moving the tips of the packing forks in a generally kidney-shaped path of travel. The packer is thus used to receive materials from the pickup 36 and pack the same into the duct 38 for preparing a precompressed, preshaped charge of crop materials that conforms generally to the interior dimensions of the duct 38 while the opening is closed by the reciprocating plunger. The stuffer, as is conventional and well understood by those skilled in the art, functions to sweep through its own kidney shaped path of travel to sweep the prepared charge up into baling chamber 30 between compression strokes of the plunger when the opening is uncovered.

The pickup 36 includes a retracting tine rotor of conventional construction wherein rake tines sweep upwardly along the front of the portion of the rotor, rearwardly at the top portion of rotor, and then downwardly along the rear portion thereof. Such tines project through slots defined between wrapper straps that are looped around the front of rotor. The tines are subject to cam-action, thereby remaining generally radial throughout their path of travel except along the rear stretch thereof where the tines retract straight down between straps while disposed in an upright condition to release the crop material.

The effective operating width of the pickup 36 is wider than the inlet into the duct 38. Thus, the pickup 36 is operable to pick up windrows of crop material that are substantially wider than the inlet.

In one embodiment, an imaging system embodied as plural cameras, such as one of the pairs 44 depicted in FIG. 1B, is mounted to the frame towards the lateral, front ends of the baler 28, within range of the windrow that is to be collected by the pickup 36. The same or additional cameras of the imaging system may be mounted elsewhere on the baler, such as on the tongue 34, mounted to and extended from the top of the baler 28, or on the towing vehicle within range of the windrow, among other locations. As described above in association with FIG. 1A and applicable in association with FIG. 1B, the imaging system may operate within the visible or non-visible spectrum, and may be operable to capture image pairs (or in some embodiments, provide a stereo image) and provide to a processing system of the WRYD system for further processing.

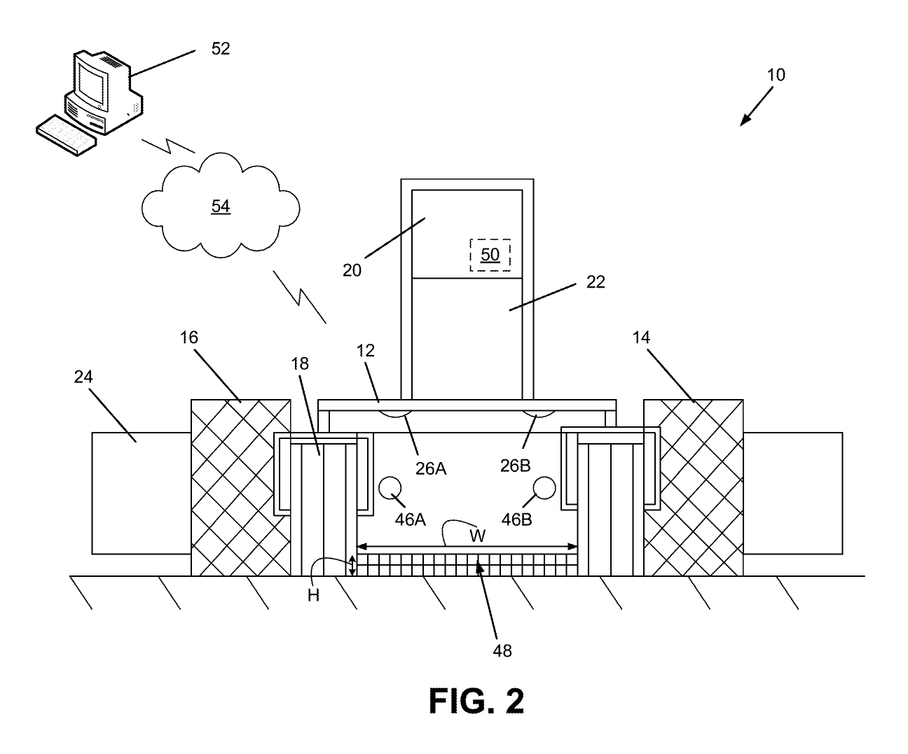

FIG. 2 depicts a schematic diagram of the windrower 10 in a rear-end, elevation view. It should be appreciated that certain components of the windrower 10 have been omitted here to avoid obscuring certain features of a WRYD system. Certain features of the windrow 10 have already been described in association with FIG. 1A, and hence discussion of the same is omitted here for brevity except where noted otherwise. In the embodiment depicted in FIG. 2, the imaging system comprises cameras 26A and 26B mounted to the frame 12 of the windrow 10 and spaced a fixed or adjustable distance apart to enable stereoscopic imaging. As noted above, the cameras 26A and 26B may be located elsewhere, or in some embodiments, additional cameras may be mounted to the agricultural machine, such as mounted to the header 24 as shown by cameras 46A and 46B. In one embodiment, the cameras 46A, 46B share similar features to those described for cameras 26A, 26B, and hence further discussion of the same is omitted here for brevity. In some embodiments, different types of cameras may be used on the same agricultural machine. As shown in FIG. 2, the cameras 26A and 26B and cameras 46A and 46B are positioned within range of a windrow 48 that, in this example, is produced from the cutting mechanisms of the header 24. The windrow 48 has a given height, H, and width, W, depending on the elevation of the header 24, the amount of crop in the field, and the presence of any deflectors that may narrow the windrow 48.

In one embodiment, and assuming the imaging system only consists of cameras 26A and 26B for the example windrower 10, plural images of the windrow 48 are captured by the cameras 26A and 26B and may be communicated (e.g., over a wired connection or network, such as via a controller area network (CAN), or wirelessly) to a processing system 50 located in the cab 20 or elsewhere on the agricultural machine (e.g., windrower 10). The communication of images of the windrow may be implemented regularly (e.g., periodically, every defined quantity of feet of travel of the windrower, every fixed time interval, etc.) or irregularly or aperiodically (e.g., responsive to a given event, such as operator intervention locally or remotely, or at random intervals). In some embodiments, the processing of the images and/or determination of cross sectional area and/or yield maps may be performed in real time, or in some embodiments, in non-real time.

The processing system 50 may include a computer or controller or other computing device embodied in a single package (e.g., enclosure) or distributed among several components. The processing system 50, as explained below, may receive the plural images and pair the images to provide a stereoscopic image. As is known, the stereoscopic image may be decomposed into, or otherwise represented by, a point cloud, which the processing system 50 uses to determine a cross sectional area of the windrow 48. In some embodiments, a point cloud may be generated at the camera 26A and 26B and provided to the processing system 50 for determination of the cross sectional area of the windrow 48. In some embodiments, the stereoscopic image may be communicated by one or more of the cameras 26A and 26B to the processing system 50, which then generates the point cloud and determines the cross sectional area. The processing system 50 may then determine (e.g., approximate) the relative yield across a given (e.g., defined) area, and display the same on a computer monitor or other display device (or in some embodiments, store to memory or generally a computer readable medium) located proximally to, or remotely from, the processing system 50. The area may be defined and indexed through the assistance of spatial data provided with each image capture (e.g., spatial data stamp), such as through cooperation with a global positioning system (GPS) or other mechanisms.

In some embodiments, the images (e.g., paired or stereoscopic images) of the windrow 48, the stereoscopic images, and/or the point cloud, may be communicated to a processing system 52 located remotely from the windrower 10 (e.g., in a farm management office, famer's home, or elsewhere). Such communication may be performed over a network 54 (e.g., wireless network). The processing system 52 may perform similar processing to that described above for the processing system 50. Note that in some embodiments, the image data may be stored on a removable memory (e.g., memory stick, computer disk, etc.) and transferred (e.g., manually) to another location for further processing. In some embodiments, the processing system 52 may include a wireless communications device, laptop, computer, server, among other electronic devices with a processor and memory.

It should be appreciated within the context of the present disclosure that one embodiment of a WRYD system may include all of the components depicted in, and described in association with, FIG. 2. In some embodiments, the WRYD system may encompass a portion (e.g., less that the entirety) of the components depicted and described in association with FIG. 2, including, as mentioned above, the substitution of a different agricultural machine for use in mounting the imaging system.

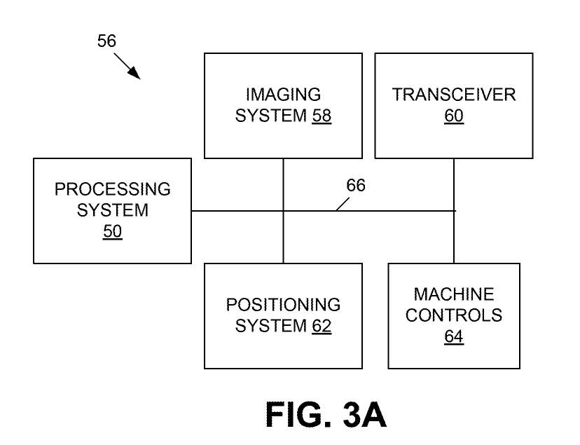

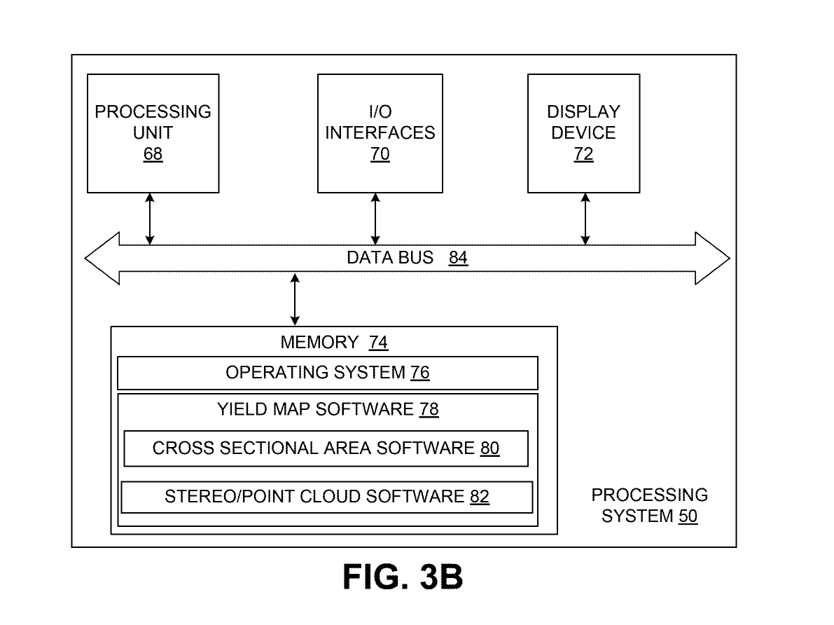

Attention is now directed to FIG. 3A, which illustrates an embodiment of a control portion of a WRYD system, denoted as control system 56. It should be appreciated within the context of the present disclosure that some embodiments may include additional control features or fewer or different control features, and that the example depicted in FIG. 3A is merely illustrative of one embodiment among others. Further, the control portion of the WRYD system may be implemented by all or a portion (e.g., less than all) of the components depicted in, and described in association with, FIGS. 3A-3B. The control system 56 comprises the processing system 50 (though in some embodiments, the processing system 52 may be employed in addition to or in lieu of the processing system 50) coupled in a CAN network 66 (though not limited to a CAN network or a single network) to the imaging system 58, a transceiver 60, positioning system 62 (e.g., global positioning system or GPS, geographic information system (GIS), etc.), and machine controls 64. The imaging system 58 has been described already, and may include visible and non-visible spectrum devices, such as cameras, laser radar technology, etc. The positioning system 62 enables the detection of a geofence or mapped areas, as well the detection of vehicle positioning and/or location (e.g., of the windrower 10 or baler 28. Such information may be used to create a spatial data stamp with each image capture for purposes of identifying a field portion in a yield map. The transceiver 60 enables the communication of information, such as the plural images, stereoscopic images, point clouds, cross sectional area information, yield maps, etc. to other devices and/or networks (e.g., including mesh networks), including the processing system 52.

The machine controls 64 collectively represent the various actuators, sensors, and/or controlled devices residing on the agricultural machine (e.g., windrower 10, baler 28, tractor, etc.), including those used to control machine navigation, header information including header type (e.g., including width, height, etc.), header position, windrow deflectors, etc.

The processing system 50 receives and processes the information from the imaging system 58, the positioning system 62, and/or the machine controls 64 (e.g., directly, or indirectly through an intermediary device in some embodiments, such as a local controller), and based on the information, may generate for the captured images of the windrow, stereoscopic images, point clouds, cross sectional areas, and/or yield maps. The processing system 50, or in some embodiments, the imaging system 58, may cause the communication of the images or determined data to a remote location via the transceiver 60.

FIG. 3B further illustrates an example embodiment of the processing system 50. One having ordinary skill in the art should appreciate in the context of the present disclosure that the example processing system 50 is merely illustrative, and that some embodiments of processing systems may comprise fewer or additional components, and/or some of the functionality associated with the various components depicted in FIG. 3B may be combined, or further distributed among additional modules, in some embodiments. The processing system 50 is depicted in this example as a computer system. It should be appreciated that certain well-known components of computer systems are omitted here to avoid obfuscating relevant features of the processing system 50. In one embodiment, the processing system 50 comprises one or more processing units, such as processing unit 68, input/output (I/O) interface(s) 70, an optional display device 72, and memory 74, all coupled to one or more data busses, such as data bus 84. The memory 74 may include any one or a combination of volatile memory elements (e.g., random-access memory RAM, such as DRAM, and SRAM, etc.) and nonvolatile memory elements (e.g., ROM, hard drive, tape, CDROM, etc.). The memory 74 may store a native operating system, one or more native applications, emulation systems, or emulated applications for any of a variety of operating systems and/or emulated hardware platforms, emulated operating systems, etc. In the embodiment depicted in FIG. 3B, the memory 74 comprises an operating system 76, and yield map software 78 that in one embodiment comprises cross sectional area software 80 and stereo/point cloud software 82. It should be appreciated that in some embodiments, additional or fewer software modules (e.g., combined functionality) may be employed in the memory 74 or additional memory. In some embodiments, a separate storage device may be coupled to the data bus 84, such as a persistent memory (e.g., optical, magnetic, and/or semiconductor memory and associated drives).

The yield map software 78 prepares an estimate of the relative yield (e.g., among spatially-identified portions of a field the agricultural machine traverses). The cross sectional area software 80 determines the cross sectional area of the windrow 48 based on the stereo images and/or point cloud determined by the stereo/point cloud software 82. The input to the yield map software 78 comprises plural images of the windrow as captured by the imaging system 58 and communicated over the network 76 to the I/O interface 70 and data bus 84.

Execution of the software modules 76-82 is implemented by the processing unit 68 under the management of the operating system 76. In some embodiments, the operating system 76 may be omitted and a more rudimentary manner of control implemented. The processing unit 68 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the processing system 50.

The I/O interfaces 70 provide one or more interfaces to the network 76 and/or network 54, as well as interfaces for access to computer readable mediums, such as memory drives, which includes an optical, magnetic, or semiconductor-based drive. In other words, the I/O interfaces 70 may comprise any number of interfaces for the input and output of signals (e.g., analog or digital data) for conveyance over the network 76 and/or 54. The input may comprise input by an operator (local or remote) through a keyboard or mouse or other input device (or audible input in some embodiments), and input from signals carrying information from one or more of the components of the control system 56.

The display device 72 comprises one of a variety of types of displays, including liquid crystal diode (LCD), plasma, among others, that provide an outputted GUI to the operator as indicated above. Note that in some embodiments, the display device 72 may be a headset-type display.

The transceiver 70 includes functionality to enable wired or wireless communication, such as locally or via a network to a remote location. As a non-limiting example, the transceiver 70 may include a modulator/demodulator (e.g., a modem), wireless (e.g., radio frequency (RF)) transceiver, a telephonic interface, among other network components.

When certain embodiments of the processing system 50 are implemented at least in part as software (including firmware), as depicted in FIG. 3B, it should be noted that the software can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the computer system 24 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

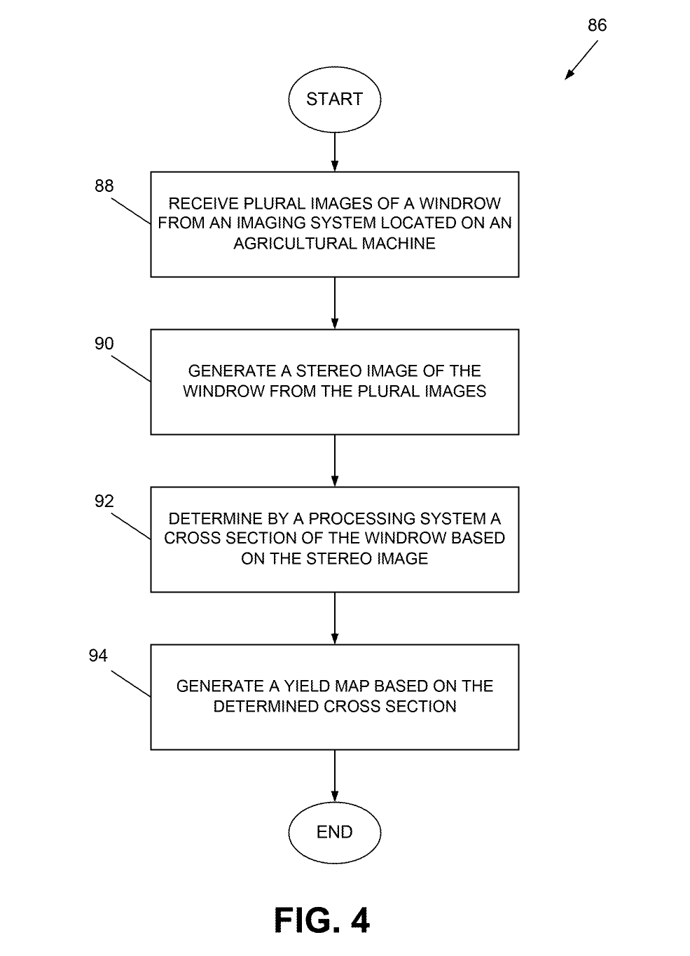

Having described certain embodiments of a WRYD system, it should be appreciated within the context of the present disclosure that one embodiment of a WRYD method, denoted as method 86 as illustrated in FIG. 4, comprises receiving plural images of a windrow from an imaging system located on an agricultural machine (88); generating a stereo image of the windrow from the plural images (90); determining by a processing system a cross section of the windrow based on the stereo image (92); and generating a yield map based on the determined cross section (94).

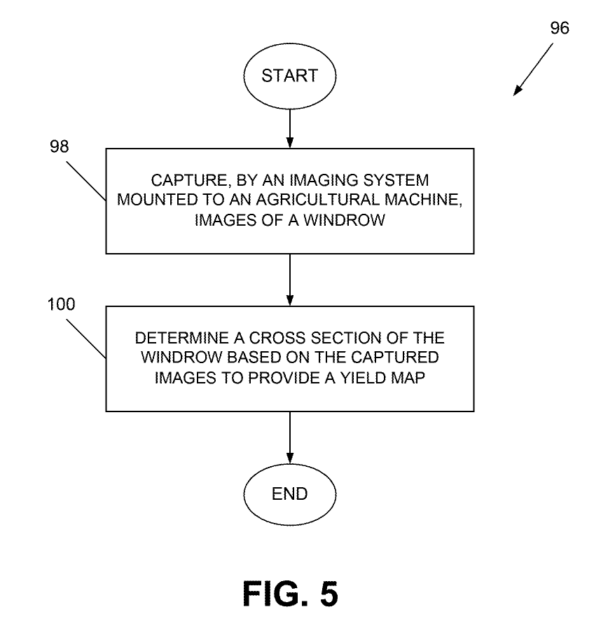

In view of the above description, it should be appreciated that yet another WRYD method embodiment, denoted as method 96 and illustrated in FIG. 5, comprises capturing, by an imaging system mounted to an agricultural machine, images of a windrow (98); and determining a cross section of the windrow based on the captured images to provide a yield map (100).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present invention, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A method, comprising:
receiving plural images of a windrow from an imaging system located on an agricultural machine;
generating a stereo image of the windrow from the plural images;
determining by a processing system a cross section of the windrow based on the stereo image; and
generating a yield map based on the determined cross section.

2. The method of claim 1, wherein generating a yield map is further based on additional information.

3. The method of claim 2, wherein the additional information comprises one or any combination of spatial data or header width of an agricultural machine.

4. The method of claim 1, wherein determining further comprises generating a point cloud corresponding to the stereo image.

5. The method of claim 1, wherein operation of the imaging system is based on a visible spectrum of light or non-visible spectrum of light.

6. The method of claim 1, wherein receiving comprises receiving in real-time or non-real time.

7. The method of claim 1, wherein receiving comprises receiving regularly or irregularly.

8. The method of claim 1, wherein the processing system resides in the agricultural machine or remotely from the agricultural machine.

9. The method of claim 1, wherein the imaging system comprises plural cameras.

10. A system, comprising:
an agricultural machine comprising an imaging system configured to capture images of a windrow;
a processing system configured to:
determine a cross section of the windrow based on input from the imaging system; and
generate a yield map based on the determined cross section.

11. The system of claim 10, wherein the agricultural machine is located remotely from the processing system.

12. The system of claim 10, wherein the agricultural machine comprises the processing system.

13. The system of claim 10, wherein the processing system is configured to receive a stereo image from the imaging system.

14. The system of claim 10, wherein the processing system is configured to receive plural images from the imaging system, generate a stereo image based on the plural images, and determine the cross section based on the stereo image.

15. The system of claim 10, wherein the imaging system comprises a laser radar topography measurement system.

16. The system of claim 10, wherein the imaging system comprises plural cameras.

17. The system of claim 10, wherein operation of the imaging system is based on a visible spectrum of light or non-visible spectrum of light.

18. The system of claim 10, wherein the processing system is configured to determine, generate, or determine and generate at a time proximal to receiving the input or not proximal to receiving the input.

19. The system of claim 10, wherein the processing system is configured to receive the input periodically or aperiodically.
